(19) United States
(12) Patent Application Publication
(10) Pub. No.: US 2013/0061258 A1
(43) Pub. Date: Mar. 7, 2013

(54) PERSONALIZED TELEVISION VIEWING MODE ADJUSTMENTS RESPONSIVE TO FACIAL RECOGNITION

(71) Applicants: Norifumi Takaya, San Diego, CA (US); John D. Smith, Fallbrook, CA (US); Kai Liu, San Diego, CA (US); David Tao, San Diego, CA (US)

(72) Inventors: Norifumi Takaya, San Diego, CA (US); John D. Smith, Fallbrook, CA (US); Kai Liu, San Diego, CA (US); David Tao, San Diego, CA (US)

(73) Assignee: SONY CORPORATION, Tokyo (JP)

(21) Appl. No.: 13/224,596

(22) Filed: Sep. 2, 2011

(51) Int. Cl. H04H 60/33

(52) U.S. Cl. 725/10

(57) ABSTRACT

A television apparatus for performing personalized viewing mode adjustments in response to identifying individual viewers. A camera and image/facial recognition subsystems are configured to identify individuals and retrieve stored viewing adjustment preference information for use in automatically adjusting the viewing mode of the television, and optional external devices (e.g., electronically controlled lights, shades, and so forth), to enhance the television viewing experience for individuals and groups.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to television sets, and more particularly to a television that automatically adjusts viewing characteristics in response to retrieving personalized adjustment information for a user, or users, based on facial recognition of persons proximal said television.

2. Description of Related Art

Videophiles and even casual users are becoming increasingly discerning about the characteristics and settings of their home television. Each user, for example, may have their own preferences as to aspects including favorite channels, channel lineup, volume, dynamic sound, style of picture, style of sound, brightness, color rendition and so forth. It is recognized that the home television viewing environment is subject to a wide range of ambient conditions, and in many households different persons with different likes and dislikes share one or more televisions.

Presently, each user must either settle with the present settings of the television, or laboriously make changes that will be likely over-ridden when someone else utilizes the set. Due to these difficulties, the settings often remain in a non-optimal configuration for each given user.

Accordingly, the present invention provides a means of automatically personalizing viewing mode adjustments in a manner which overcomes the shortcomings of previous television viewing control mechanisms.

### BRIEF SUMMARY OF THE INVENTION

The television in the present invention automatically adjusts view settings and optionally the environmental factors in response to facial recognition of viewers as their images are captured by a camera. Upon identifying one or more individuals (or groups), the system retrieves viewing mode adjustment preferences which were previously stored for that individual (or group), such as established during a setup procedure and modified as desired thereafter.

It should be appreciated that the term “viewing mode” is recited herein in a broad sense to mean all factors affecting the viewing and listening experience of the television, and not just those relating to the TV display. For example viewing mode adjustments as subject to control herein can include, but are not limited to: favorite channels, channel lineup, style of picture, picture format, brightness, contrast, color adjustment, volume, dynamic sound, style of sound, state of external lighting devices, state of external shading devices, and state of other elements which affect the television experience.

By way of example and not limitation, the inventive television apparatus can automatically set the list of favorite channels and the channel lineup, in response to who, or whom, is identified as being proximal the viewing area of the television. The use of favorite channels and channel lineups provide speedy access to channels which are most pertinent to a given user. In addition, the television apparatus can configure its output characteristics, such as style of picture, picture format, brightness, contrast, color adjustment, volume, dynamic sound, style of sound, and so forth, based on user preferences for these elements. Still further, the television apparatus can control external devices based on these user preference to further enhance the television viewing experience.

It should also be noted that the innovative television described herein can apply these automatic adjustments regardless of the media programming source being output (e.g., over-the-air (OTA) broadcasts, cable broadcasts, satellite broadcasts, network broadcast, media playback (DVD, Blu-Ray™, Hard disk, streaming video box, slinging-video), and so forth without limitation).

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a television set apparatus configured for automatically controlling operating parameters according to an embodiment of the present invention, showing a computer and memory within the apparatus.

FIG. 2 is a flow diagram of television viewing parameter control by a television configured with facial recognition according to an embodiment of the present invention.

FIG. 3 is a flow diagram of a configuration process for setting up the personal viewing parameters according to an embodiment of the present invention.

### DETAILED DESCRIPTION OF THE INVENTION

The television apparatus according to the invention provides a novel personalized automatic control of viewing mode adjustments based on facial recognition. The innovative television system can be configured according to the invention for properly adjusting viewing modes under a wide range of conditions. Any number and extent of personalized viewing adjustments can be performed according to the present invention, such as including but not limited to: style of picture, picture format, brightness, contrast, color adjustment, volume, dynamic sound, style of sound, state of external lighting devices, state of external shading devices, and state of other elements which affect the television experience.

The system according to at least one embodiment determines who the viewer is (e.g., identification), retrieves their desired viewing conditions (e.g., record for the identified viewer), inputs this data in some cases into a computation which takes into account ambient conditions (e.g., adjusting brightness or sound levels in relation to ambient lighting or sound), to automatically arrive at a personalized set of viewing conditions for each given user. It should be appreciated that the system does not merely determine if there are persons present near the television device (e.g., in the viewing area), but actually determines the identity of these individuals, and uses this identification for accessing preference records for the individual which contain information on their preferred viewing mode adjustments. Personal recognition permits a level of viewing mode control adjustment which was not previously available.

In at least one embodiment, the system can optionally obtain additional information which is not entered in the user's preferences, such as time, date, information about content being played (e.g., program guide), and so forth, but which can be utilized in combination with those preferences in making desired viewing adjustments. This extra data can be obtained from circuits or sensors within the television (e.g., date, time of day, light level, sound level) or through a communication channel (e.g., through a wide area network (Internet) connection) toward automatically adjusting the viewing environment to suit conditions. By way of example the picture brightness can be adjusted in response to user preferences and modified in relation to detected light levels, or similarly in response to date and time. The style of output can be adjusted to suit the content being played back; for example selecting playback style based on user preferences in combination with information about the type of media content being played (e.g., movie, documentary, serial, or similar media content).

The adjustment process can control viewing parameters of the television itself, as well as in at least one embodiment control external mechanisms/elements, such as lighting, blinds, skylights, external sound sources and any other devices which can be configured for electronic control by the inventive television device. By way of example and not limitation, the television system in this embodiment is configured to communicate over a local interface (and/or over an wide area network (WAN) or Internet) to control aspects of the local environment, for instance communicating over a wired (e.g., power-line network, USB, and so forth), or wireless (e.g., Wi-Fi, radio signal, and so forth), interface for controlling external devices, such as those relating to ambient lighting, shades, sound sources, and other devices capable of environmental control.

In addition, the personalization based on facial recognition can operate in combination with other sensing being performed by the television. For example, the input from the camera can also be utilized for sensing ambient lighting levels in the room (e.g., lights being on, off, or intermediate light levels, sun intensity), or even the color of the ambient light, insofar as the lighting elements are within, or at least near the field of view of the camera subsystem. This information can be utilized in combination with the user preference settings to assure that the viewing mode adjustments are made properly. It will be appreciated for example, that greater display brightness is needed in high ambient lighting conditions than at low lighting conditions.

Similarly, the deployment state of room shades can be sensed by the camera if reasonably within the field of view. Other sensors, cameras and/or status communication mechanisms can be incorporated into the system to suit any given environment, so that the condition/state of controllable elements can be accurately determined and then controlled by the inventive television device.

When more than one individual is watching the television, the viewing mode can be adjusted to one of the individuals (e.g., priority selection mode) and/or a compromise viewing configuration as desired (e.g., averaging mode). In one mode of the system, viewing mode adjustments are further adjusted in response to positioning or movement of the individuals with respect to the television device. Still further, external information can be obtained by the system and utilized in making the viewing mode adjustments.

The present invention provides a number of beneficial elements which can be implemented either separately or in any desired combination without departing from the present teachings.

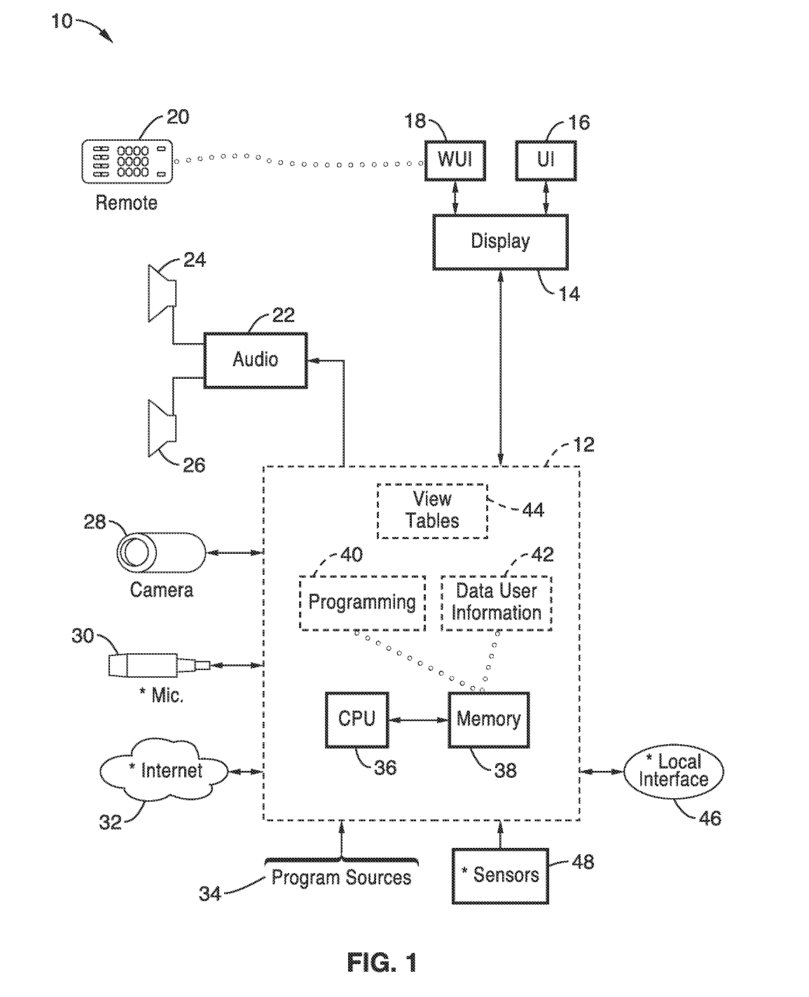

FIG. 1 illustrates an example embodiment 10 of a television with personalized viewing mode adjustments which operates in response to image recognition, and more preferably facial recognition. It will be noted that image recognition according to the invention can provide information on the presence of an individual(s) as well as their general stature, while facial recognition can assure making a positive identification of any given individual. So in general facial recognition is more accurate in identifying specific individuals. However, image recognition is still preferably also utilized for making quick identity estimations if the user's face is not sufficiently visible (e.g., distant, turned, covered, etc.), as well as for assuring a proper identification distinction, such as for discerning a parent from a similar-appearing progeny.

A control subsystem 12 of the television is configured to control a number of input and output devices, including at least one television display 14, user interface devices represented by a manual user interface 16, wireless user interface 18 and associated remote control 20. Audio can be generated over an audio subsystem 22 having one or more audio annunciators (speakers), such as speakers 24, 26 to provide stereo output. An image capture device (e.g., subsystem) 28 is shown configured for capturing still images and/or streaming of video images proximal the television apparatus. For the sake of simplicity, and not limitation, the camera is shown without external lighting, variable focusing or zooming elements. It will be appreciated that any form of enhanced camera features can be supported. In one embodiment of the invention, the television camera preferably includes infrared light sources (e.g., one or more elements, such as light-emitting diodes (LEDs), for instance in a ring configuration about the lens of the camera. The inclusion of infrared lighting in certain embodiments of the invention, allows for proper operation of the image/facial recognition programming even in low ambient lighting situations which are common during television viewing. In one mode of the invention, the programming is configured to perform image recognition, and preferably including facial recognition, in response to light output from the display and to automatically compensate for color and intensity levels based on the color, patterns and intensity output from the television display.

An optional microphone 30, whose optional nature is depicted by the asterisk in the figure, is also shown for supporting verbal recognition according to at least one embodiment of the present invention. In addition, an optional wide area network (WAN) interface 32 is shown, whose optional nature is also depicted by an asterisk in the figure, such as for providing connectivity to the Internet as utilized automatically by the viewing mode adjustment mechanisms of the present invention. As with any television, it is capable of receiving media information from a variety of program sources 34, such as from set-top boxes (STB), cable inputs, video players, over-the-air (OTA) programming, and other video and/or audio media sources without limitation.

Control subsystem 12 of the television apparatus includes at least one computer processing element, depicted as a central processing unit (CPU) 36 coupled to memory 38 for storing programming 40 executable on processor 36, as well as data including user information 42 with image recognition patterns, selection preferences, and other desired data, along with viewing tables 44 as necessary for use in determining viewing mode adjustments in response to ambient conditions. It will be appreciated that elements of the present invention can also be implemented as programming stored on a media and configured for use within a television apparatus having an associated image capture device.

The television set is configured to recognize individuals and groups of individuals as registered by camera 28, and to which a set of selection preferences are associated, so that upon detecting the individual through image/facial recognition their respective preference settings and history can be retrieved (looked up), such as from a database of user records.

During operation, the television set captures images of the proximal viewing area and performs image and/or facial recognition and a lookup to determine identities of those present and to obtain their preference settings, history data and other information which are useful according to the preference settings.

During operation the television set makes viewing adjustments, thus personalizing them, in response to determining the identities of the parties. In addition, the user can utilize the inventive device to extend viewing adjustments outside the television environment, whereby other controllable devices whose activity or state impacts the television experience (e.g., primarily sight and sound, but not limited thereto) are adjusted. For example, in bright daylight, electrically controlled blinds may be drawn, liquid crystal shutters closed, sound sources muted, devices turned on or off, climate control settings adjusted, and any functions automatically controlled as desired by the user, insofar as these devices are configured for and communicatively coupled to the television set. An optional local interface 46, whose optional nature is indicated by an asterisk in the figure, allows for direct control of aspects of the local environment, for instance communicating over a wired (e.g., power-line network, USB, and so forth), or wireless (e.g., Wi-Fi, radio signal, and so forth), interface for controlling external devices.

In addition, the preference settings themselves are preferably interpreted in at least one embodiment in response to externally obtained information, such as external sensor information, date and time information, almanac information on sun set and rise times, weather information, programming information (e.g., show times, user content preferences), and other information which can aid the television system in personalizing viewing adjustments. It should be appreciated that the additional information can be obtained from within the television device itself (e.g., date and time from a real time clock), the use of optional external sensors 48 (e.g., ambient lighting, temperature), whose optional nature is depicted by the asterisk in the figure. Additional information may also be retrieved through communications networks (e.g., the internet), and so forth without limitation, while operating in cooperation with user preference settings to enhance the personalization of the viewing experience.

In optional embodiments, the personalization of viewing mode adjustments can register input from the user, such as gestures which are registered through camera 28 in response to image recognition, and/or utilizing speech recognition through optional microphone 30.

Preference settings describe what the user prefers in regards to viewing adjustments that are to be processed by the system for each individual (or group), and provide information about users which allows the system to support a wider range of internal and external adjustments. It will be noted that information for identifying each individual (e.g., image and facial recognition) is considered to be contained in the preference settings, or alternatively within a separate database. It should be appreciated, that databases can be merged or separated in any desired manner without departing from the teachings of the present invention.

It will be noted that although a group is a collection of individuals, the preference settings provide for generating different verbal outputs when addressing an arbitrary group, or a select group. For example, the persons in a household, although having individual preference settings, could be addressed by a group preference setting when more than one are present, or in response to the presence of specific persons from the group.

One of ordinary skill in the art will recognize that the functions and elements of the present invention described above may be implemented in alternative ways without departing from the invention. Accordingly, the present personalized viewing adjustment television device can be described as a plurality of means elements operating cooperatively for the television to respond to image/facial recognition, and to adjust television preferences automatically.

The inventive television apparatus may be implemented with any particular hardware means as described in relation to FIG. 1. A means for controlling the television 12 provides interoperative control of various functions and method steps, such as comprising displaying video images, image recognition, retrieval of preference information and making viewing adjustments, for instance in response to operation of electronic hardware and program executions performed separately or in combinations thereof. A means is provided for displaying video images 14 to the user, while a means for collecting user input is provided for collecting direct user input (e.g., tactile) input 16 and/or user input over a wireless connection 18, such as from a remote device 20. A means for generating audio output 22 is provided through which the system can output audio associated with the image or video displayed on means for display 14. A means for capturing images 28 allows the television to operate for capturing still images and/or video images proximal the television apparatus. The television is configured with a means for receiving media content 34 for output on the television. Optionally, the television apparatus comprises means for performing verbal recognition 30 on verbal input from the user, wherein audio input is audio processed by control means 12 for recognizing verbal input from the user. A means is preferably (optionally) included for establishing connection 32 with a wide area network, such as the Internet.

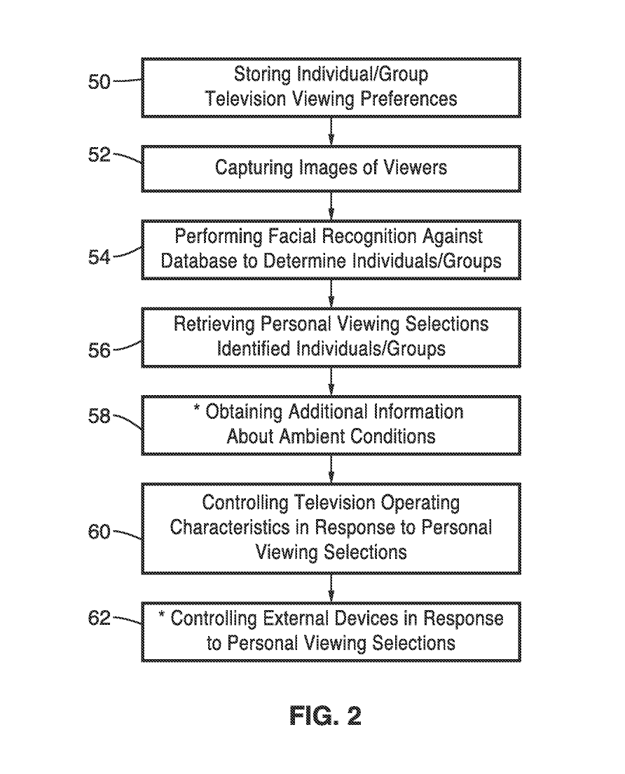

FIG. 2 illustrates an example embodiment of the automated personalized viewing adjustments according to the invention. In at least one embodiment of the invention preferences are stored 50 for one or more individuals (or groups). Once configured, the television captures images (e.g., stills or video) 52 of those in the area of the television, preferably those in the primary viewing area for watching the television set.

Once these images are captured, then image recognition is performed 54, preferably facial recognition or at least including facial recognition, to identify individuals and groups. The identification of individuals and groups is performed with respect to a database of characteristics to determine which individuals are present. If multiple persons are present it is determined if they define a group for which additional information is available. Personal viewing selections are then retrieved 56 on how to adjust the respective viewing modes for each individual or group of individuals. It will be noted, however, that modes of the invention can set default adjustments without preference settings. Still further, in at least one implementation the television requests that the user identify themselves, for instance by remote control or keypad entries, or verbally if the television is equipped for speech recognition, or by any other desired input means. In this way the system can without limitation obtain information “on-the-fly”, to increase the personalization of viewing adjustments.

In at least one embodiment, the television system obtains additional information 58, which is an optional step as indicated by the asterisk shown in the figure. By way of example and not limitation, the additional information may comprise: date, time, program guide information, and so forth, for use in setting television operating characteristics. This information can be obtained from the television device itself (e.g., date-time circuit, camera ambient lighting detection) or in response to external communications, exemplified as an optional wide area network 32 shown in FIG. 1. The personal identification allows for retrieval of individual or group preference settings for the television, from which the viewing adjustments are made 60. In at least one embodiment, the television is also optionally configured for controlling external devices 62, in response to viewing preferences, such as lights, blinds, skylights, sound sources, and other elements which can affect the television experience.

In at least one embodiment, the optional retrieval of additional information 58 can include the registering of viewer gestures and/or viewer verbal input to optimize personalization of viewing mode adjustments. It will be appreciated that gesture recognition can be performed using information from the camera, if the camera is configured to provide a sufficient framing rate, with this information being processed according to known techniques for determining gestures utilizing image recognition programming. By way of example and not limitation, gestures can comprise any desired association between gesture and command, such as considering an up-pointing finger movement hand motion as a command for the television to increase audio volume, or a slashing gesture to mute the television, or other gestures as desired without limitation to control other viewing mode adjustments. Alternatively, the recognition of speech input requires utilizing speech recognition programming on audio captured by the television, such as through an optional microphone 30 shown in FIG. 1. The use of gestures and/or speech input from the users can augment the adjustment performed based on personalized viewing preferences within the present invention.

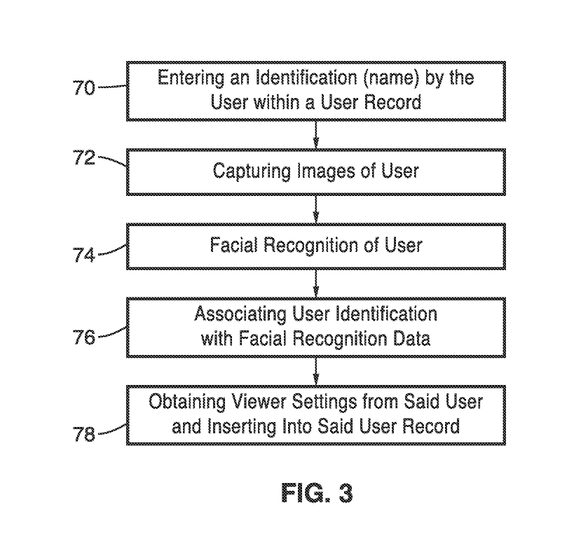

FIG. 3 illustrates an example embodiment of a setup process for configuring the television device for making personalized viewing adjustments. By way of example and not limitation, during a setup process the programming directs users to identify themselves 70, wherein a user record is created, or otherwise associated with the user. In one aspect the user can supply a text of their name, or otherwise enter or select an identifier. Images are captured 72 of the user with image/facial recognition performed 74, and associated with the user identification 76. The recognition data (e.g., point sets, templates or other descriptors according to available recognition algorithms) is stored for later access by the image/facial recognition programming which can match up captured images with the database of users. User preferences are collected 78 for this identified user and associated with this individual user (or optionally for use by a group), such as being stored within a record structure associated with the identified user.

It will also be appreciated that during other processes and circumstances the user can be identified by the system. For example, in one mode the television system captures images for unknown parties and automatically stores image and/or facial recognition data. At some point, such as if the same individual repeatedly uses the television a given number of times, they can be queried to enter their desired viewing mode adjustments, and optionally to identify themselves.

The present invention provides methods and apparatus for making personalized television viewing mode adjustments which are responsive to image/facial recognition, and can be implemented with a wide range of optional modes and embodiments.

As can be seen, therefore, the present invention includes the following inventive embodiments among others:

1. A television apparatus, comprising: means for displaying video images of received media programming; means for generating an audio output; means for collecting user input; means for capturing images of areas proximal said apparatus as captured images; means for controlling said displaying of video images and said generating of audio output in response to input from said means for collecting user input; and means for generating personalized viewing mode adjustments in response to performing facial recognition on said captured images to identify individuals proximal the viewing area of said television apparatus and retrieve associated stored preferences that are utilized in generating said personalized viewing mode adjustments from said apparatus.

2. A television apparatus, comprising: a display subsystem configured for displaying video images; a user interface configured for user selection of media programming and operating characteristics of said television apparatus; a camera subsystem; a computer configured for controlling said display subsystem in response to input from said user interface and said camera subsystem; and programming executable on said computer for: controlling said camera subsystem for capturing images of individuals proximal said television apparatus; performing facial recognition against a database to identify at least one individual within a field of view of said camera subsystem; retrieving stored viewing adjustment preference information for said at least one individual; and automatically controlling viewing mode adjustments for said television apparatus in response to retrieval of said stored viewing adjustment preference information.

3. The apparatus as recited in embodiment 2, wherein said television apparatus does not merely adjust settings in response to determining that persons are proximal said television apparatus, but actually determines an identity of these individuals, and uses this identification for accessing viewing adjustment preference information for the individual from which operating characteristics of said television apparatus are controlled.

4. The apparatus as recited in embodiment 2, further comprising programming executable on said computer for storing said viewing adjustment preference information for individuals.

5. The apparatus as recited in embodiment 2, further comprising programming executable on said computer for utilizing status information that is not contained in viewing adjustment preference information, and using this status information in combination with said viewing adjustment preference information, during said controlling of operating characteristics.

6. The apparatus as recited in embodiment 5, further comprising programming executable on said computer for communicating through a wide area network connection in operative communication with said apparatus for obtaining said status information.

7. The apparatus as recited in embodiment 5, wherein said status information is selected from the group of status information consisting of date, time, and program guide information.

8. The apparatus as recited in embodiment 2, wherein said viewing mode adjustments for said television apparatus are selected from the group of viewing mode adjustments consisting of favorite channels, channel lineup, style of picture, picture format, brightness, contrast, color adjustment, volume, dynamic sound, and style of sound.

9. The apparatus as recited in embodiment 2, further comprising programming executable on said computer for determining ambient television viewing conditions, and for utilizing said ambient television viewing conditions in combination with said viewing adjustment preference information in controlling said viewing mode adjustments for said television apparatus.

10. The apparatus as recited in embodiment 2, further comprising: programming executable on said computer for controlling external devices in response to said viewing adjustment preference information; wherein operational state of said external devices affects the visual and/or audio portions of a viewing experience with said television apparatus.

11. The apparatus as recited in embodiment 10, wherein said external devices are selected from the group of external devices consisting of external lighting devices and external shading devices.

12. The apparatus as recited in embodiment 2, wherein said viewing adjustment preference information is selected from the group of preferences consisting of favorite channels, favorite shows, viewing history, display settings, audio settings, viewing times, ambient lighting conditions.

13. The apparatus as recited in embodiment 2, wherein said at least one individual comprises multiple individuals within a group of individuals for which viewing adjustment preference information is available in a group mode.

14. The apparatus as recited in embodiment 13, further comprising programming executable on said computer for selecting one of multiple group modes, based on user preferences, as selected from the group of group modes consisting of priority selection, averaging, weighted averaging, and combinations thereof.

15. The apparatus as recited in embodiment 1, further comprising programming executable on said computer for performing content control personalization, wherein media program content is changed, paused, or stopped in response to individual identification.

16. A television apparatus, comprising: a display subsystem configured for displaying video images; user interface configured for user selection of media programming and operating characteristics of said television apparatus; a camera subsystem; a computer configured for controlling said display subsystem in response to input from said user interface and said camera subsystem; and programming executable on said computer for: storing viewing mode adjustment information for individuals which are viewing and/or interacting with said television apparatus; controlling said camera subsystem for capturing images of individuals viewing and/or interacting with said television apparatus; performing facial recognition against a database to identify at least one individual within the camera field of view; retrieving stored viewing adjustment preference information for said at least one individual; and controlling viewing mode adjustments for said television apparatus based on retrieval of said stored viewing adjustment preference information; wherein said television apparatus does not merely adjust settings in response to determining if the number of persons which are proximal the television device, but actually determines the identity of these individuals, and uses this identification for accessing viewing adjustment preference information for the individual which is used for controlling operating characteristics of said television apparatus.

17. The apparatus as recited in embodiment 16, wherein said viewing mode adjustments for said television apparatus are selected from the group of viewing mode adjustments consisting of favorite channels, channel lineup, style of picture, picture format, brightness, contrast, color adjustment, volume, dynamic sound, and style of sound.

18. The apparatus as recited in embodiment 16, wherein said viewing adjustment preference information is selected from the group of preferences consisting of favorite channels, favorite shows, viewing history, display settings, audio settings, viewing times, ambient lighting conditions.

19. The apparatus as recited in embodiment 16, further comprising programming executable on said computer for determining ambient television viewing conditions.

20. The apparatus as recited in embodiment 19, further comprising programming executable on said computer for controlling external devices in response to viewing adjustment preference information and said ambient television viewing conditions.

Another embodiment of the invention is a television which automatically adjusts its viewing mode characteristics (without the need of user intervention) in response to identification of specific users/viewers via image recognition, and/or more particularly in response to facial recognition.

Another embodiment of the invention is a television set having at least one associated and/or integrated camera for capturing images proximal to the television, and more particularly the area in front of the screen within which the television is normally viewed.

Another embodiment of the invention is a television which stores viewing mode preferences for individual viewers which utilize the television set.

Another embodiment of the invention is a television which selects a default set of viewing mode settings when individual viewers can not be recognized, or for which no personalized adjustment data has been registered.

Another embodiment of the invention is a television set which personalizes viewing modes in response to different groups (composition of individuals).

Another embodiment of the invention is a television set which allows selection of multiple group viewing modes, including priority selection, averaging, weighted averaging, and combinations thereof.

Another embodiment of the invention is a television set which controls viewing adjustments in response to personal identification in combination with additional information, such as date, time, program guide information, either obtained from the television device or from external communications.

Another embodiment of the invention is a television set which is configured with content control personalization, wherein media program content is changed, paused (e.g., and blanked), or stopped in response to individual identification, such as determining that a child has entered the viewing area of the television.

Another embodiment of the invention is a television set which controls the state of external devices (e.g., lights, blinds, skylights, sound sources, and other elements which can impact the television experience) when automatically adjusting viewing mode for an identified viewer.

Another embodiment of the invention is a television set which does not merely adjust settings in response to determining if any one or more persons are present near the television device (e.g., proximal the viewing area), but actually determines the identity of these individuals, and uses this identification for accessing preference records for the individual containing information on their preferred viewing mode adjustments.

Another embodiment of the invention is a television set which performs viewing mode personalization based on image recognition, and more preferably facial recognition.

Another embodiment of the invention is a television set which personalizes viewing adjustments in response to identifying who the viewer is and retrieving their desired viewing conditions.

Another embodiment of the invention is a television set which performs viewing mode personalization which takes into account the sensing of ambient viewing conditions (light levels and locations, light settings, sound levels, and so forth).

Another embodiment of the invention is a television set in which personalized viewing preference settings are combined into a computation having variables, such as ambient light intensity, and/or other ambient factors, to calculate how each of the controllable elements in the environment should be adjusted.

Another embodiment of the invention is a television which can utilize personalized verbal output, as described in a companion Sony patent application, to provide selected feedback to users in response to select viewing adjustments, in particular those relating to devices external to the television set, such as lights, shades, and so forth.

A still further embodiment of the invention is a television which can operate fully conventionally, or utilizing the automated viewing adjustment control.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A television apparatus, comprising:
means for displaying video images of received media programming;
means for generating an audio output;
means for collecting user input;
means for capturing images of areas proximal said apparatus as captured images;
means for controlling said displaying of video images and said generating of audio output in response to input from said means for collecting user input; and
means for generating personalized viewing mode adjustments in response to performing facial recognition on said captured images to identify individuals proximal the viewing area of said television apparatus and retrieve associated stored preferences that are utilized in generating said personalized viewing mode adjustments from said apparatus.

2. A television apparatus, comprising:
a display subsystem configured for displaying video images;
a user interface configured for user selection of media programming and operating characteristics of said television apparatus;
a camera subsystem;
a computer configured for controlling said display subsystem in response to input from said user interface and said camera subsystem; and
programming executable on said computer for:
controlling said camera subsystem for capturing images of individuals proximal said television apparatus;
performing facial recognition against a database to identify at least one individual within a field of view of said camera subsystem;
retrieving stored viewing adjustment preference information for said at least one individual; and
automatically controlling viewing mode adjustments for said television apparatus in response to retrieval of said stored viewing adjustment preference information.

3. The apparatus as recited in claim 2, wherein said television apparatus does not merely adjust settings in response to determining that persons are proximal said television apparatus, but actually determines an identity of these individuals, and uses this identification for accessing viewing adjustment preference information for an individual from which operating characteristics of said television apparatus are controlled.

4. The apparatus as recited in claim 2, further comprising programming executable on said computer for storing said viewing adjustment preference information for individuals.

5. The apparatus as recited in claim 2, further comprising programming executable on said computer for utilizing status information that is not contained in viewing adjustment preference information, and using this status information in combination with said viewing adjustment preference information, during said controlling of operating characteristics.

6. The apparatus as recited in claim 5, further comprising programming executable on said computer for communicating through a wide area network connection in operative communication with said apparatus for obtaining said status information.

7. The apparatus as recited in claim 5, wherein said status information is selected from the group of status information consisting of date, time, and program guide information.

8. The apparatus as recited in claim 2, wherein said viewing mode adjustments for said television apparatus are selected from the group of viewing mode adjustments consisting of favorite channels, channel lineup, style of picture, picture format, brightness, contrast, color adjustment, volume, dynamic sound, and style of sound.

9. The apparatus as recited in claim 2, further comprising programming executable on said computer for determining ambient television viewing conditions, and for utilizing said ambient television viewing conditions in combination with said viewing adjustment preference information in controlling said viewing mode adjustments for said television apparatus.

10. The apparatus as recited in claim 2, further comprising:
programming executable on said computer for controlling external devices in response to said viewing adjustment preference information;
wherein operational state of said external devices affects visual and/or audio portions of a viewing experience with said television apparatus.

11. The apparatus as recited in claim 10, wherein said external devices are selected from a group of external devices consisting of external lighting devices and external shading devices.

12. The apparatus as recited in claim 2, wherein said viewing adjustment preference information is selected from a group of preferences consisting of favorite channels, favorite shows, viewing history, display settings, audio settings, viewing times and ambient lighting conditions.

13. The apparatus as recited in claim 2, wherein said at least one individual comprises multiple individuals within a group of individuals for which viewing adjustment preference information is available in a group mode.

14. The apparatus as recited in claim 13, further comprising programming executable on said computer for selecting one of multiple group modes, based on user preferences, as selected from a group of group modes consisting of priority selection, averaging, weighted averaging, and combinations thereof.

15. The apparatus as recited in claim 1, further comprising programming executable on said computer for performing content control personalization, wherein media program content is changed, paused, or stopped in response to individual identification.

16. A television apparatus, comprising:
a display subsystem configured for displaying video images;
user interface configured for user selection of media programming and operating characteristics of said television apparatus;
a camera subsystem;
a computer configured for controlling said display subsystem in response to input from said user interface and said camera subsystem; and
programming configured executable on said computer for:
storing viewing mode adjustment information for individuals which are viewing and/or interacting with said television apparatus;
controlling said camera subsystem for capturing images of individuals viewing and/or interacting with said television apparatus;
performing facial recognition against a database to identify at least one individual within a field of view of said camera subsystem;
retrieving stored viewing adjustment preference information for said at least one individual; and
controlling viewing mode adjustments for said television apparatus based on retrieval of said stored viewing adjustment preference information;
wherein said television apparatus does not merely adjust settings in response to determining if a number of persons are proximal the television device, but actually determines the identity of these individuals, and uses this identification for accessing viewing adjustment preference information for an individual which is used for controlling operating characteristics of said television apparatus.

17. The apparatus as recited in claim 16, wherein said viewing mode adjustments for said television apparatus are selected from a group of viewing mode adjustments consisting of favorite channels, channel lineup, style of picture, picture format, brightness, contrast, color adjustment, volume, dynamic sound, and style of sound.

18. The apparatus as recited in claim 16, wherein said viewing adjustment preference information is selected from a group of preferences consisting of favorite channels, favorite shows, viewing history, display settings, audio settings, viewing times, ambient lighting conditions.

19. The apparatus as recited in claim 16, further comprising programming executable on said computer for determining ambient television viewing conditions.

20. The apparatus as recited in claim 19, further comprising programming executable on said computer for controlling external devices in response to viewing adjustment preference information and said ambient television viewing conditions.
